(19) United States
(12) Patent Application Publication
(10) Pub. No.: US 2013/0285570 A1
(43) Pub. Date: Oct. 31, 2013

(54) LED DRIVING CIRCUIT, LED DRIVING DEVICE AND DRIVING METHOD

(71) Applicant: Chi-Jen KUO, Taipei (TW)

(72) Inventor: Chi-Jen KUO, Taipei (TW)

(21) Appl. No.: 13/617,972

(22) Filed: Sep. 14, 2012

(30) Foreign Application Priority Data
Apr. 27, 2012 (TW) 101115237

(51) Int. Cl. H05B 37/02

(52) U.S. Cl. 315/294; 315/291

(57) ABSTRACT

A LED driving circuit applied to a LED module includes a read address generating unit, a memory cell and a driving unit. The read address generating unit receives a clock signal and outputs a reading signal. The memory cell is coupled to the read address generating unit and generates an output signal in accordance with the reading signal. The driving unit is coupled to the memory cell, receives the output signal and the clock signal and outputs a driving signal to the LED module. A LED driving device and a driving method are also disclosed.

### CROSS REFERENCE TO RELATED APPLICATIONS

This Non-provisional application claims priority under 35 U.S.C. §119(a) on Patent Application No(s). 101115237 filed in Taiwan, Republic of China on Apr. 27, 2012, the entire contents of which are hereby incorporated by reference.

### BACKGROUND OF THE INVENTION

1. Field of Invention

The invention relates to a light emitting diode (LED) driving circuit, a LED driving device and a LED driving method.

2. Related Art

Because the light emitting diode (LED) has the higher opto-electronic conversion efficiency and the high operation stability and has the luminance that can be controlled (also referred to as the gray scale control) by way of pulse width modulation (PWM), the LEDs have been applied to various light sources or display elements in various electronic devices, such as a backlight module of a display device, an illumination device, an advertising billboard or image pixels of a large-scale display device.

Referring to FIG. 1A, a conventional LED driving circuit 1 has a data register unit 11, a counter 12, a comparator 13 and a driver 14. The data register unit 11 receives and stores the gray scale information coming from the system end (not shown). The counter 12 receives the clock signal outputted from the system end. The comparator 13 has a first end 131 coupled to the data register unit 11, and a second end 132 coupled to the counter 12. The first end 131 and the second end 132 receive the signals outputted from the data register unit 11 and the counter 12, respectively. The comparator 13 compares the signals, received by the first end 131 and the second end 132, with each other. When the signal received by the first end 131 is higher than the signal received by the second end 132, the output terminal of the comparator 13 has a logic high potential, so that the driver 14 lights up the LED with a constant current source. When the signal received by the second end 132 is higher than the signal received by the first end 131, the output terminal of the comparator 13 has the logic low potential. At this time, the driver 14 does not light up the LED. Therefore, as shown in FIG. 1B, the driver 14 outputs a PWM signal in accordance with the comparison result of the comparator 13, so that the LED generates the luminance with different gray scales, and a turn-on time interval T₁ of the PWM signal in a duty cycle T is a continuous turn-on time interval. The gray scale represents the brightness/darkness level of the luminance, and the conventional LED driving circuit 1 makes the LED to output different luminance levels through the PWM signal outputted from the driver 14. As the turn-on time interval T₁ gets longer, the time for lighting the LED gets longer and the luminance gets brighter. On the contrary, as the turn-on time interval T₁ gets shorter, the luminance becomes darker. When the turn-on time interval T₁ is zero, it represents that the LED is extinguished.

In order to compare the signals, coming from the data register unit 11 and the counter 12, with each other, however, the comparator 13 of the conventional LED driving circuit 1 is composed of a lot of metal-oxide-semiconductor field-effect transistors (MOSFETs). For example, when the comparator 13 uses a 12-bit comparator, the comparator 13 has at least 864 MOSFETs. Because the MOSFET itself has the defects of the leakage current and the parasitic capacitance, the comparator 13 using a lot of MOSFETs has the problem of the additional power loss.

It is an important subject to provide a LED driving circuit, capable of reducing unessential loss of the power and enhancing the processing performance, and a LED driving device and a LED driving method.

### SUMMARY OF THE INVENTION

In view of the foregoing subject, an object of the invention is to provide a LED driving circuit, capable of reducing unessential loss of the power and enhancing the processing performance, and a LED driving device and a LED driving method.

To achieve the above objective, a light emitting diode (LED) driving circuit, according to the invention, applied to a LED module comprises a read address generating unit, a memory cell, and a driving unit. The read address generating unit receives a clock signal and outputting a reading signal. The memory cell is coupled to the read address generating unit and generates an output signal in accordance with the reading signal. The driving unit is coupled to the memory cell, receives the output signal and the clock signal, and outputs a driving signal to the LED module.

In one embodiment, the clock signal is a binary weighted clock signal.

In one embodiment, the read address generating unit comprises a read address counter and a read address decoder. The read address counter receives the clock signal. The read address decoder is coupled to the read address counter and outputs the reading signal.

In one embodiment, the driving signal has a plurality of turn-on time intervals in a duty cycle, and the turn-on time intervals are not continuous.

In one embodiment, the driving unit comprises a flip-flop and a driver. The flip-flop is coupled to the memory cell and receives the output signal and the clock signal. The driver is connected to the flip-flop and outputs the driving signal.

In one embodiment, the memory cell is a two-port static random access memory.

In one embodiment, the LED driving circuit further comprises a write address generating unit and a shift register. The write address generating unit is coupled to the memory cell and outputs a writing signal to the memory cell in accordance with a latch enable signal. The shift register is coupled to the memory cell.

In one embodiment, the write address generating unit comprises a write address counter and a write address decoder. The write address counter receives the latch enable signal. The write address decoder is coupled to the write address counter and outputs the writing signal.

To achieve the above objective, a driving method of a light emitting diode (LED) module applied to a LED driving circuit, the LED driving circuit having a read address generating unit, a memory cell and a driving unit, the driving method comprises: receiving a clock signal and outputting a reading signal to the memory cell by the read address generating unit; generating an output signal in accordance with the reading signal by the memory cell; and receiving the output signal and the clock signal and outputting a driving signal to the LED module by the driving unit.

In one embodiment, the clock signal is a binary weighted clock signal.

In one embodiment, the driving method further comprises: outputting a writing signal to the memory cell in accordance with a latch enable signal through a write address generating unit.

To achieve the above objective, a light emitting diode (LED) driving device, applied to a plurality of LED modules, comprises a plurality of memory cells, a write address generating unit, a read address generating unit, and a plurality of driving units. The memory cells are coupled in parallel. The write address generating unit generates a writing signal in accordance with a latch enable signal. The read address generating unit receives a clock signal and outputting a reading signal to each of the memory cells. The driving units are coupled to the corresponding memory cells, respectively. One of the memory cells writes a gray scale signal in accordance with the writing signal, each of the memory cells outputs an output signal to the corresponding driving unit in accordance with the reading signal, each of the driving units outputs a driving signal to the corresponding LED module in accordance with the output signal and the clock signal.

In one embodiment, the clock signal is a binary weighted clock signal.

In one embodiment, the read address generating unit comprises a read address counter and a read address decoder. The read address counter receives the clock signal. The read address decoder is coupled to the read address counter and outputs the reading signal.

In one embodiment, the driving signal has a plurality of turn-on time intervals in a duty cycle, and the turn-on time intervals are not continuous.

In one embodiment, each of the driving units comprises a flip-flop and a driver. The flip-flop is coupled to the corresponding memory cell and receives the output signal and the clock signal. The driver is connected to the flip-flop and outputs the driving signal.

In one embodiment, the memory cell is a two-port static random access memory.

In one embodiment, the write address generating unit comprises a write address counter and a write address decoder. The write address counter receives the latch enable signal. The write address decoder is coupled to the write address counter and outputs the writing signal.

To achieve the above objective, a driving method of a light emitting diode (LED) module is applied to a LED driving device, the LED driving device having a plurality of memory cells, a write address generating unit, a read address generating unit and a plurality of driving units. The driving method comprises: receiving a clock signal and outputting a reading signal to each of the memory cells by the read address generating unit; outputting an output signal to the corresponding driving unit in accordance with the reading signal by each of the memory cells; and outputting a driving signal to the corresponding LED module in accordance with the output signal and the clock signal by each of the driving units.

In one embodiment, the driving method further comprises: generating a writing signal in accordance with a latch enable signal by the write address generating unit; and writing a gray scale signal in accordance with the writing signal by one of the memory cells.

As mentioned above, the LED driving circuit, the LED driving device and the LED driving method in accordance with the invention generate the output signal by the memory cell in accordance with the reading signal outputted from the read address generating unit, and enable the driving unit to drive the LED module in accordance with the output signal and the clock signal, thereby decreasing the unessential power loss and enhancing the processing performance.

### BRIEF DESCRIPTION OF THE DRAWINGS

The invention will become more fully understood from the detailed description given herein below illustration only, and thus is not limitative of the present invention, and wherein:

FIG. 1A is a schematic illustration showing a conventional LED driving circuit;

FIG. 1B shows waveforms of PWM signals outputted by the conventional LED driving circuit;

FIG. 2A is a schematic illustration showing a LED driving circuit in accordance with a preferred embodiment of the invention;

FIG. 2B shows waveforms of a clock signal and a driving signal in accordance with the preferred embodiment of the invention;

FIG. 3 is a schematic illustration showing the LED driving circuit in accordance with the preferred embodiment of the invention;

FIG. 4 is a flow chart showing a driving method of a LED module in accordance with the preferred embodiment of the invention;

FIG. 5 is a schematic illustration showing a LED driving device in accordance with the preferred embodiment of the invention; and

FIG. 6 is a flow chart showing a driving method of a LED module in accordance with another preferred embodiment of the invention.

### DETAILED DESCRIPTION OF THE INVENTION

The present invention will be apparent from the following detailed description, which proceeds with reference to the accompanying drawings, wherein the same references relate to the same elements.

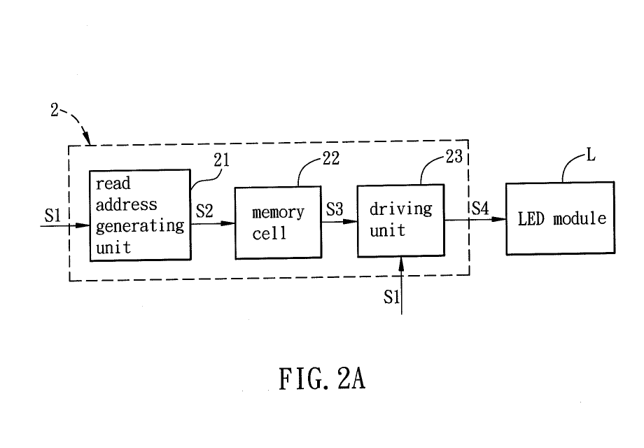

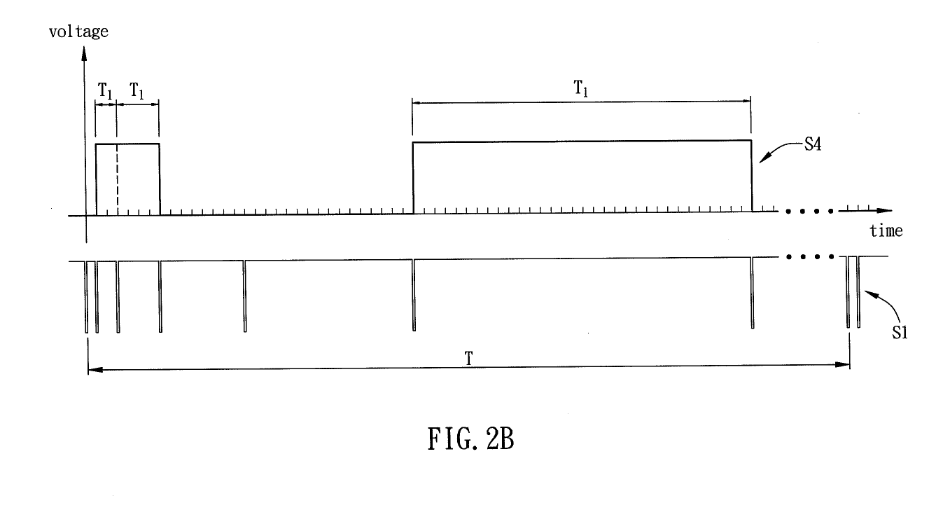

Referring first to FIG. 2A, a LED driving circuit 2, according to a preferred embodiment of the invention, applied to a LED module L includes a read address generating unit 21, a memory cell 22 and a driving unit 23. The LED module L includes at least a LED. It is to be specified that, in practice, the LED module L may have different numbers of LEDs in accordance with different used requirements or design considerations, and the connection between the LEDs may be modified in accordance with the requirement.

The read address generating unit 21 receives a clock signal S1 coming from the system end (not shown), performs the counting in accordance with the clock signal S1 and outputs a reading signal S2, which is a signal for specifying to read a specific bit. The system end is, for example, a pulse signal generator, which is applied to the LED driving circuit 2 and may be disposed in another circuit or another device.

In this embodiment, the clock signal S1 is a binary weighted clock signal. That is, as shown in FIG. 2B, each pulse of the clock signal S1 is based on a time width of a previous pulse and generated in a binary manner. For example, if the width of the first pulse is 2⁰, the pulse of the second pulse is 2¹ and the width of the third pulse is 2², then the following pulses are sequentially doubled. The widths of the pulse are continuously doubled to the upper bound of count of the read address generating unit 21. For example, when the count range of the read address generating unit 21 is from 0 to 11, the width of the pulse returns to the pulse width of 2⁰ after the width of the pulse is doubled to 2¹¹. Then, the width of the pulse is sequentially doubled in the same manner.

The memory cell 22 is coupled to the read address generating unit 21, selects a signal corresponding to the specific bit in accordance with the reading signal S2 outputted from the read address generating unit 21, and outputs an output signal S3, which represents a gray scale signal. In the implementation, the memory cell 22 is a two-port static random access memory (SRAM).

The driving unit 23 is coupled to the memory cell 22, receives the output signal S3 outputted from the memory cell 22 and the clock signal S1 provided by the system end (not shown), and outputs a driving signal S4 to the LED module L. The clock signal S1 received by the driving unit 23 and the clock signal S1 received by the read address generating unit 21 originate from the same pulse signal generator.

In the implementation, the driving signal S4 is a PWM signal, and the LED module L generates the luminance with different gray scales in accordance with the turn-on time interval of the driving signal S4. In a duty cycle, the turn-on time interval of the driving signal S4 may be a continuous turn-on time interval. Alternatively, as shown in FIG. 2B, the driving signal S4 has a plurality of turn-on time intervals T₁ in the duty cycle T, and when the driving signal S4 has a plurality of turn-on time intervals T₁ in the duty cycle T, the turn-on time intervals T₁ may be in the discontinuous state. Therefore, the driving unit 23 outputs the driving signal S4 capable of modulating the width of the turn-on time interval in accordance with the luminance with the gray scale to be represented. In addition, in one duty cycle, the turn-on time interval of the driving signal S4 may be a continuous turn-on time interval, or contain multiple discontinuous turn-on time intervals.

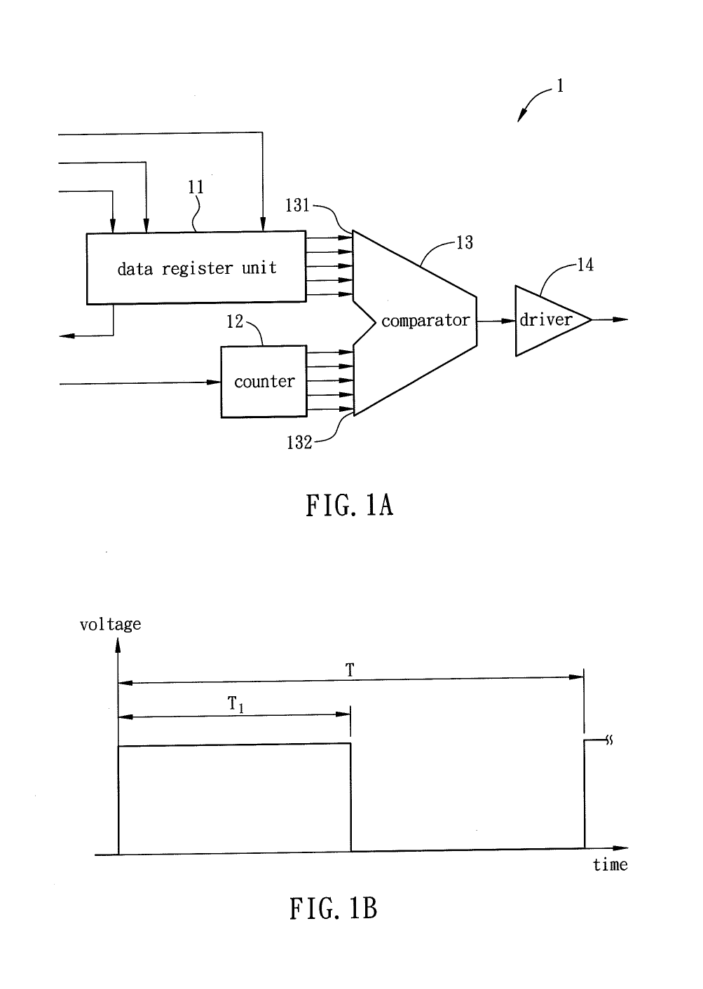

According to the above-mentioned architecture, the LED driving circuit 2 prevents the usage of the comparator composed of a lot of MOSFETs, and thus improves the unessential power loss in the circuit and enhances the overall performance of the circuit. It is to be specified that when the memory cell 22 is a 12-bit two-port SRAM, it only has 96 MOSFETs. Therefore, the LED driving circuit 2 can decrease the unessential power loss, and can also reduce the area used for the circuit layout under the condition of executing the driving function the same as that of the conventional LED driving circuit 1 (see FIG. 1A).

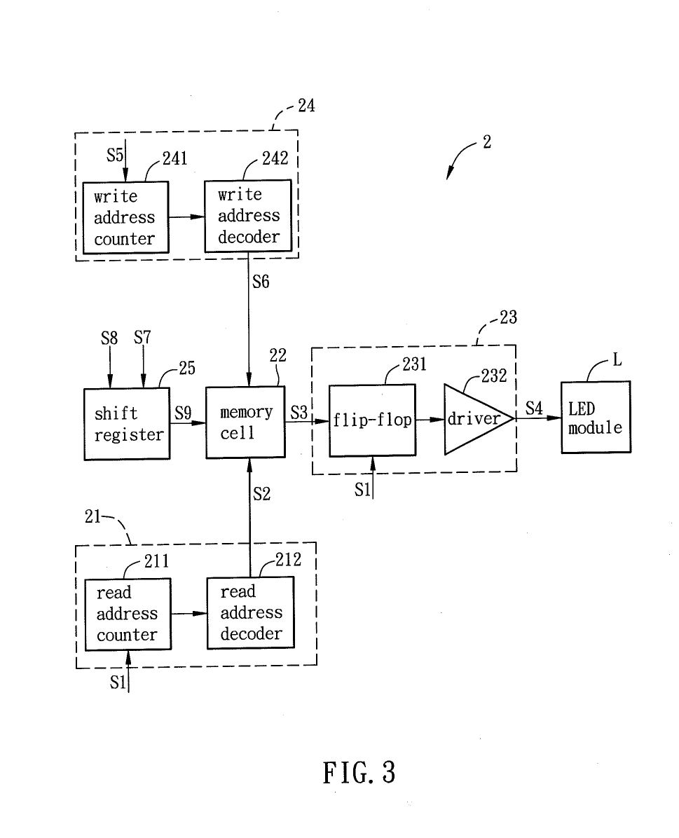

Next, as shown in FIG. 3, the LED driving circuit 2 of the invention will be further described. In this embodiment, the read address generating unit 21 includes a read address counter 211 and a read address decoder 212. The read address counter 211 receives the clock signal S1 provided by the system end (not shown), performs the counting in accordance with the clock signal S1 and outputs its result. The read address decoder 212 is coupled to the read address counter 211, and generates the reading signal S2 in accordance with the result outputted from the read address counter 211.

The driving unit 23 includes a flip-flop 231 and a driver 232. The flip-flop is coupled to the memory cell 22 and receives the output signal S3 generated by the memory cell 22 and the clock signal S1 provided by the system end (not shown). The driver 232 is connected to the flip-flop 231 and outputs the driving signal S4 to the LED module L. In the implementation, the flip-flop 231 may be a D-type flip-flop, the driver 232 may be, for example, a MOSFET, and the driver 232 outputs the driving signal S4 to the LED module L in a manner of a constant current source.

In addition, the LED driving circuit 2 further includes a write address generating unit 24 and a shift register 25. The write address generating unit 24 is coupled to the memory cell 22 and has a write address counter 241 and a write address decoder 242. The write address counter 241 receives a latch enable signal S5 provided by the system end (not shown) and performs the counting. The write address decoder 242 is coupled to the write address counter 241 and generates a writing signal S6 in accordance with the output of the write address counter 241. The write address decoder 242 transfers the writing signal S6 to the memory cell 22. The shift register 25 is coupled to the memory cell 22 and receives a clock signal S7 and an input signal S8 and provides a gray scale signal S9 to the memory cell 22. The memory cell 22 writes the gray scale signal S9 into a specific address in accordance with the writing signal S6. The clock signal S7, received by the shift register 25, and the clock signal S1, received by the driving unit 23 and the read address generating unit 21, originate from different pulse signal generators. Thus, the clock signal S7 and the clock signal S1 have completely different waveforms. In addition, the input signal S8 is a signal representing the gray scale information and is essentially the same as the gray scale signal S9.

It is to be specified that, in this embodiment, the memory cell 22 is a two-port SRAM, and the input port of the memory cell 22 connected to the shift register 25 only allows the writing function. In addition, when the data is written, the data is written into the memory cell 22 in a parallel transmission manner; and when the data is read, a specific single bit is read. Therefore, the memory cell 22 can read the data of the same address while writing the data, and it is unnecessary to perform the reading operation after the data writing operation is finished. In other words, the memory cell 22 can allow two different clock signal systems to write data into and read data from the same address concurrently without waiting, thereby reducing the circuit complexity.

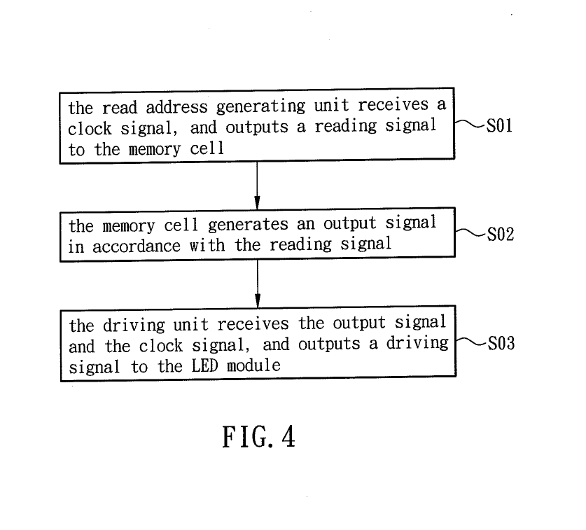

Next, the driving method of the LED module according to the preferred embodiment of the invention will be described with reference to the flow chart of FIG. 4 in conjunction with FIGS. 2A, 2B and 3. The driving method may be applied to the LED driving circuit 2 and the LED module L, and includes steps S01 to S03.

In the step S01, the read address generating unit 21 receives a clock signal S1, and outputs a reading signal S2 to the memory cell 22. In this embodiment, the read address generating unit 21 receives the clock signal S1 coming from the system end, such as the signal generated by a pulse signal generator, performs the counting and thus outputs the reading signal S2 to the memory cell 22. The clock signal S1 is a binary weighted clock signal. That is, each pulse of the clock signal S1 is based on a time width of a previous pulse and generated in a binary manner, and the width of the pulse is continuously doubled to the upper bound of count of the read address generating unit 21 and then returns to the initial value.

In the step S02, the memory cell 22 generates an output signal S3 in accordance with the reading signal S2. In this embodiment, the memory cell 22 selects the signal corresponding to the specific bit in accordance with the reading signal S2, and outputs the output signal S3, which represents a gray scale signal. The memory cell 22 is a two-port SRAM.

In the step S03, the driving unit 23 receives the output signal S3 and the clock signal S1, and outputs a driving signal S4 to the LED module L. In this embodiment, the driving unit 23 receives the output signal S3 outputted from the memory cell 22 and the clock signal S1 provided by the system end, and thus outputs the driving signal S4 to the LED module L. The driving signal S4 is a PWM signal. In the implementation, the turn-on time interval of the driving signal S4 may be a continuous turn-on time interval or contain multiple discontinuous turn-on time intervals in a duty cycle.

In a duty cycle, if the sum of the discontinuous turn-on time intervals is equal to the sum of the continuous turn-on time intervals, the luminance sensed by the human eyes will be the same. Thus, according to the above-mentioned driving method, the invention can achieve the control of the gray scale of the LED module L by modulating the discontinuous turn-on time intervals or the continuous turn-on time interval of the driving signal S4.

In addition, the driving method further includes the step, in which the write address generating unit 24 outputs a writing signal S6 to the memory cell 22 in accordance with a latch enable signal S5. In this embodiment, the write address generating unit 24 receives the latch enable signal S5 provided by the system end, performs the counting and thus outputs the writing signal S6 to the memory cell 22, so that the memory cell 22 writes the gray scale signal S9 coming from the shift register 25. The system end is, for example, a signal generator applied to a LED driving circuit 2.

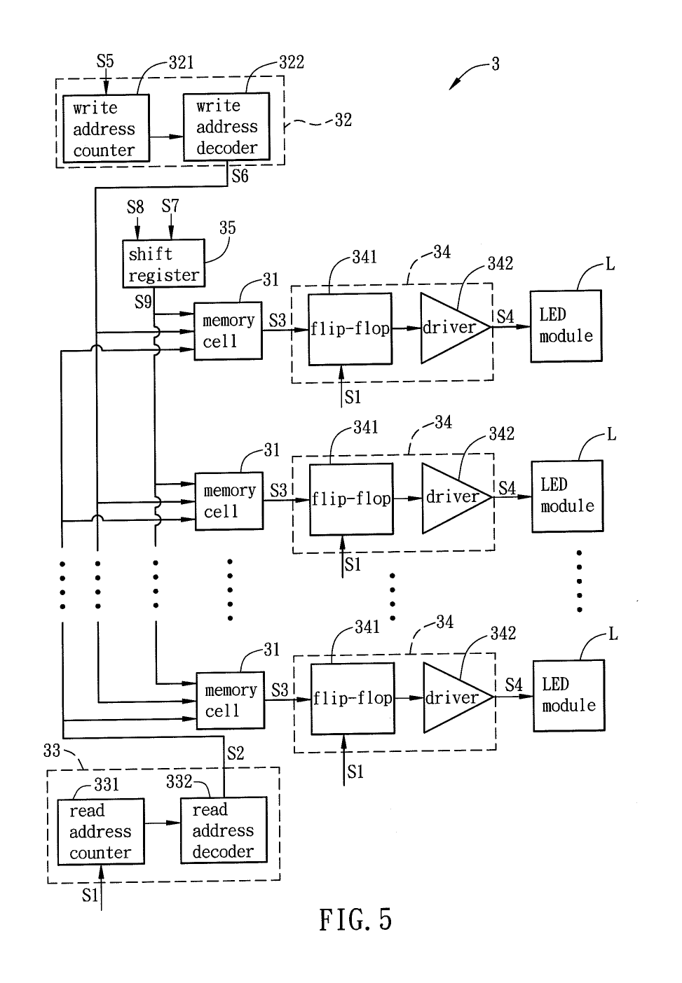

Next, as shown in FIG. 5, a LED driving device 3 in accordance with the preferred embodiment of the invention is applied to a plurality of LED modules L and includes a plurality of memory cells 31, a write address generating unit 32, a read address generating unit 33 and a plurality of driving units 34.

The memory cells 31 are coupled together in parallel. In this embodiment, each memory cell 31 is a 12-bit two-port SRAM, and the LED driving device 3 totally has 16 memory cells 31 in the illustrative but non-restrictive example.

The write address generating unit 32 generates a writing signal S6 in accordance with a latch enable signal S5 provided by the system end. The write address generating unit 32 has a write address counter 321 and a write address decoder 322. The write address counter 321 is a 4-bit write address counter, while the write address decoder 322 is a 4-input-16-output write address decoder. The write address counter 321 performs the counting in accordance with the latch enable signal S5 and generates the writing signal S6 through the write address decoder 322, so as to write the gray scale signal S9 into one of the sixteen memory cells 31. In other words, the writing signal S6 is for specifying the memory cell 31 into which the gray scale signal S9 is written.

The read address generating unit 33 receives a clock signal S1 provided by the system end and outputs a reading signal S2 to each memory cell 31. In this embodiment, the read address generating unit 33 includes a read address counter 331 and a read address decoder 332. The read address counter 331 is a 4-bit read address counter, while the read address decoder 332 is a 4-input-12-output read address decoder. The clock signal S1 provided by the system end is for driving the read address counter 331. The read address decoder 332 receives the output of the read address counter 331, and thus selects a certain specified bit and outputs the reading signal S2 to all the memory cells 31.

The clock signal S1 is a binary weighted clock signal. Each pulse of the clock signal S1 is based on the time width of a previous pulse and is generated in a binary manner. The width of the pulse is continuously doubled to the upper bound of count of the read address counter 331 and then returns to the initial value.

Each driving unit 34 includes a flip-flop 341 and a driver 342. Each flip-flop 341 is coupled to the corresponding memory cell 31 and receives the output signal S3 and the clock signal S1. The clock signal S1 received by the driving unit 34 and the clock signal S1 received by the read address generating unit 33 originate from the same pulse signal generator. The driver 342 is connected to the flip-flop 341, and outputs the driving signal S4 to the connected LED module L in a manner of a constant current source. The driving signal S4 is a PWM signal. In the implementation, the turn-on time interval of the driving signal S4 may be a continuous turn-on time interval, or contain multiple discontinuous turn-on time intervals in a duty cycle.

In addition, the LED driving device 3 also has a shift register 35, which is coupled to each memory cell 31, receives a clock signal S7 and an input signal S8 and provides a gray scale signal S9 to each memory cell 31. The clock signal S7 received by the shift register 35 and the clock signal S1 received by the driving unit 34 and the read address generating unit 33, originate from different pulse signal generators, so that the clock signal S7 and the clock signal S1 have completely different waveforms. In addition, the input signal S8 is a signal representing the gray scale information and is essentially the same as the gray scale signal S9.

In this embodiment, the input port of the memory cell 31 connected to the shift register 35 only allows the writing function. In addition, when the data is written, the data is written into the memory cell 31 is a parallel transmission manner; and when the data is read, a specific single bit is read. Therefore, the memory cell 31 can read the data of the same address while writing the data, and it is unnecessary to perform the reading operation after the data writing operation is finished. In other words, the memory cell 31 can allow two different clock signal systems to write data into and read data from the same address concurrently without waiting, thereby reducing the circuit complexity.

It is to be specified that when the memory cell 31, the write address counter 321, the write address decoder 322, the read address counter 331 and the read address decoder 332 with the above-mentioned specifications are adopted and 4096 gray scales need to be generated, the elements totally contain about 2,000 MOSFETs. However, if the conventional LED driving circuit 1 is adopted to generate 4096 gray scales, 17,000 MOSFETs need to be used. Thus, the used number of MOSFETs can be decreased in the LED driving device 3 of the invention, thereby decreasing the unessential power loss, significantly reducing the die size and effectively reducing the size of the device.

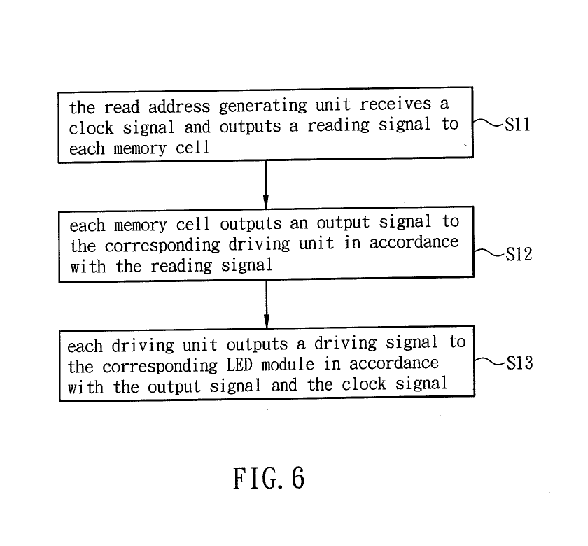

Next, the driving method of the LED module in accordance with the preferred embodiment of the invention will be described with reference to the flow chart of FIG. 6 in conjunction with FIG. 5. The driving method may be used in conjunction with the LED driving device 3 and a plurality of LED modules L and includes steps S11 to S13.

In the step S11, the read address generating unit 33 receives a clock signal S1 and outputs a reading signal S2 to each memory cell 31. In this embodiment, the clock signal S1 provided by the system end drives the read address generating unit 33 to output the reading signal S2 to all the memory cells 31. The clock signal S1 is a binary weighted clock signal.

In the step S12, each memory cell 31 outputs an output signal S3 to the corresponding driving unit 34 in accordance with the reading signal S2. In this embodiment, all the memory cells 31 select the signals corresponding to the specific bits in accordance with the reading signal S2, and generate the output signal S3. The memory cell 31 is a two-port SRAM.

In the step S13, each driving unit 34 outputs a driving signal S4 to the corresponding LED module L in accordance with the output signal S3 and the clock signal S1. In this embodiment, the driving unit 34 receives the output signal S3 and the clock signal S1, and thus outputs the driving signal S4 to the corresponding LED module L, which generates the corresponding gray scale luminance in accordance with the turn-on time interval of the driving signal S4. In addition, the driving method further includes the steps, in which the write address generating unit 32 generates a writing signal S6 in accordance with a latch enable signal S5; and one of the memory cells 31 writes a gray scale signal S9 in accordance with the writing signal S6.

In summary, the LED driving circuit, the LED driving device and the LED driving method in accordance with the invention generate the output signal by the memory cell in accordance with the reading signal outputted from the read address generating unit, and enable the driving unit to drive the LED module in accordance with the output signal and the clock signal, thereby decreasing the unessential power loss and enhancing the processing performance.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light emitting diode (LED) driving circuit applied to a LED module, the LED driving circuit comprising:
a read address generating unit receiving a clock signal and outputting a reading signal;
a memory cell, which is coupled to the read address generating unit and generates an output signal in accordance with the reading signal; and
a driving unit, which is coupled to the memory cell, receives the output signal and the clock signal, and outputs a driving signal to the LED module.

2. The LED driving circuit according to claim 1, wherein the clock signal is a binary weighted clock signal.

3. The LED driving circuit according to claim 1, wherein the read address generating unit comprises:
a read address counter receiving the clock signal; and
a read address decoder, which is coupled to the read address counter and outputs the reading signal.

4. The LED driving circuit according to claim 1, wherein the driving signal has a plurality of turn-on time intervals in a duty cycle, and the turn-on time intervals are not continuous.

5. The LED driving circuit according to claim 1, wherein the driving unit comprises:
a flip-flop, which is coupled to the memory cell and receives the output signal and the clock signal; and
a driver, which is connected to the flip-flop and outputs the driving signal.

6. The LED driving circuit according to claim 1, wherein the memory cell is a two-port static random access memory.

7. The LED driving circuit according to claim 1, further comprising:
a write address generating unit, which is coupled to the memory cell and outputs a writing signal to the memory cell in accordance with a latch enable signal; and
a shift register coupled to the memory cell.

8. The LED driving circuit according to claim 7, wherein the write address generating unit comprises:
a write address counter receiving the latch enable signal; and
a write address decoder, which is coupled to the write address counter and outputs the writing signal.

9. A driving method of a light emitting diode (LED) module applied to a LED driving circuit, the LED driving circuit having a read address generating unit, a memory cell and a driving unit, the driving method comprising:
receiving a clock signal and outputting a reading signal to the memory cell by the read address generating unit;
generating an output signal in accordance with the reading signal by the memory cell; and
receiving the output signal and the clock signal and outputting a driving signal to the LED module by the driving unit.

10. The driving method according to claim 9, wherein the clock signal is a binary weighted clock signal.

11. The driving method according to claim 9, further comprising:
outputting a writing signal to the memory cell in accordance with a latch enable signal through a write address generating unit.

12. A light emitting diode (LED) driving device, applied to a plurality of LED modules, the LED driving device comprising:
a plurality of memory cells coupled in parallel;
a write address generating unit generating a writing signal in accordance with a latch enable signal;
a read address generating unit receiving a clock signal and outputting a reading signal to each of the memory cells; and
a plurality of driving units coupled to the corresponding memory cells, respectively,
wherein one of the memory cells writes a gray scale signal in accordance with the writing signal, each of the memory cells outputs an output signal to the corresponding driving unit in accordance with the reading signal, each of the driving units outputs a driving signal to the corresponding LED module in accordance with the output signal and the clock signal.

13. The LED driving device according to claim 12, wherein the clock signal is a binary weighted clock signal.

14. The LED driving device according to claim 12, wherein the read address generating unit comprises:
a read address counter receiving the clock signal; and
a read address decoder, which is coupled to the read address counter and outputs the reading signal.

15. The LED driving device according to claim 12, wherein the driving signal has a plurality of turn-on time intervals in a duty cycle, and the turn-on time intervals are not continuous.

16. The LED driving device according to claim 12, wherein each of the driving units comprises:
a flip-flop, which is coupled to the corresponding memory cell and receives the output signal and the clock signal; and
a driver, which is connected to the flip-flop and outputs the driving signal.

17. The LED driving device according to claim 12, wherein the memory cell is a two-port static random access memory.

18. The LED driving device according to claim 12, wherein the write address generating unit comprises:
a write address counter receiving the latch enable signal; and
a write address decoder, which is coupled to the write address counter and outputs the writing signal.

19. A driving method of a light emitting diode (LED) module applied to a LED driving device, the LED driving device having a plurality of memory cells, a write address generating unit, a read address generating unit and a plurality of driving units, the driving method comprising:
receiving a clock signal and outputting a reading signal to each of the memory cells by the read address generating unit;
outputting an output signal to the corresponding driving unit in accordance with the reading signal by each of the memory cells; and
outputting a driving signal to the corresponding LED module in accordance with the output signal and the clock signal by each of the driving units.

20. The driving method according to claim 19, further comprising:
generating a writing signal in accordance with a latch enable signal by the write address generating unit; and
writing a gray scale signal in accordance with the writing signal by one of the memory cells.
